(19) United States
(12) Patent Application Publication
(10) Pub. No.: US 2026/0110784 A1
(43) Pub. Date: Apr. 23, 2026

(54) PIXEL AND DISTANCE SENSOR

(71) Applicant: Commissariat à l'Energie Atomique et aux Energies Alternatives, PARIS (FR)

(72) Inventors: Josep SEGURA PUCHADES, GRENOBLE (FR); Laurent FREY, GRENOBLE (FR); Anis DAAMI, GRENOBLE (FR)

(21) Appl. No.: 19/358,659

(22) Filed: Oct. 15, 2025

(30) Foreign Application Priority Data
Oct. 21, 2024 (FR) 2411405

(51) Int. Cl. G01S 7/4913; G01S 7/4911; G01S 7/4912; G01S 17/34

(52) U.S. Cl. CPC G01S 7/4913; G01S 7/4911; G01S 7/4917; G01S 17/34

(57) ABSTRACT

The present description concerns a pixel (PIX). A circuit (CIRC1) delivers, after each integration period corresponding to a period of transmission of a signal FMCW, first, second, third, and fourth signals (I, Q, Ic, Qc) representative of charges photogenerated in a photodetector (PD) during first, second, third, and fourth time periods, which are phase-shifted by Π/2 and repeated at an integration frequency (fs). A circuit (CIRC2) delivers a fifth signal (Πc) determined by the difference of the first and third signals (I, Ic), and a sixth signal (QQc) determined by the difference of the second and third signals (Q, Qc). A circuit (CIRC3) compares the fifth and sixth signals (Πc, QQc) with a first voltage determined by a positive threshold and a second voltage determined by a negative threshold.

### FIELD

The present description generally concerns electronic circuits. The present application more particularly concerns pixels for the acquisition of a distance to a scene and sensors comprising such pixels, where the distance acquisition is based on a measurement of frequency-modulated continuous wave (FMCW) type.

### PRIOR ART

For an FMCW-type distance measurement, a frequency-modulated continuous wave light signal is emitted by a coherent light source, for example by a laser, during a transmission period (or “chirp duration”). An optical device transmits part of the light signal, for example half of the optical power emitted by the source, towards a scene, and the other part of the light signal, for example the other half of the optical power emitted by the source, towards a pixel. The light signal transmitted towards the scene is reflected by the scene. The resulting reflected light signal is superimposed on, or adds to, the light signal that the optical device has directly transmitted to the pixel. The superimposition of these two light signals results in a periodic light signal at a frequency fR commonly called beat frequency.

For a given duration T of the transmission period and an amplitude B of the frequency modulation of the optical frequency FL of the laser, that is, a frequency modulation slope B/T of the light signal emitted by the source, frequency fR is equal to (2·z·B)/(c·T) for this transmission period, with c the speed of light and z the distance between an output of the optical device supplying the part of the light signal sent to the scene and a point in the scene having reflected this light signal towards the pixel, this point being called point in the scene associated with the pixel.

Thus, knowing B, T, and fR, it is possible to deduce therefrom, for example, to calculate the distance z between the pixel and the point in the scene associated with the pixel.

However, known pixels and sensors implementing distance measurements based on FMCW technology have various disadvantages.

### SUMMARY OF THE INVENTION

There exists a need for a pixel and for a sensor comprising a plurality of pixels adapted to the implementation of distance measurements based on FMCW technology, which overcome at least some of the disadvantages of known pixels and of known sensors implementing such distance measurements.

For example, it would be desirable to have a pixel and a sensor adapted to the implementation of distance measurements based on FMCW technology which enable to detect a given beat frequency fR in more accurate, less bulky, less complex, and/or faster fashion than in known pixels and sensors adapted to the implementation of distance measurements based on FMCW technology.

An embodiment overcomes all or part of the disadvantages of known pixels and sensors configured to implement distance measurements based on FMCW technology.

An embodiment provides a pixel comprising:
at least one photodetector;
a first circuit configured to deliver, after each integration period corresponding to a period of transmission of a frequency-modulated continuous wave light signal, first, second, third, and fourth signals representative of a quantity of charges photogenerated in said at least one photodetector during respectively first, second, third, and fourth time periods of the integration period repeated at an integration frequency, the second time periods being phase-shifted by Π/2 with respect to the first time periods, the third time periods being phase-shifted by II with respect to the first time periods, the fourth time periods being phase-shifted by 3*Π/2 with respect to the first time periods, and the first, second, third, and fourth time periods all having a same duration; a second circuit configured to deliver a fifth signal determined by the difference of the first and third signals, and a sixth signal determined by the difference of the second and third signals; and
a third circuit configured to:
   compare each of the fifth and sixth signals with a first voltage determined by a positive threshold and with a second voltage determined by a negative threshold, the positive and negative thresholds having a same absolute value. The absolute value of the positive and negative thresholds is determined so that at least one of the fifth and sixth signals is greater than the first voltage or lower than the second voltage when a light signal received by the pixel has a beat frequency equal to the integration frequency.

Another embodiment provides a sensor comprising:
one or more pixels such as defined above;
a coherent light source configured to deliver, at each transmission period, the frequency-modulated continuous wave light signal;
an optical device configured, at each transmission period, to transmit a first part of the frequency-modulated continuous wave signal to a scene and a second part of the frequency-modulated continuous wave light signal to each pixel, so that the light signal received by each pixel corresponds to the superposition of the second part of the frequency-modulated continuous wave light signal and of a reflection by a point in the scene associated with the pixel of the first part of the frequency-modulated continuous wave light signal.

According to an embodiment, the sensor comprises a control circuit configured to control a plurality of transmission periods of the frequency-modulated continuous wave signal and, at each of said plurality of transmission periods, to keep constant a slope of the frequency modulation of the frequency-modulated continuous wave light signal and to change a value of the integration frequency.

According to an embodiment, the sensor comprises a control circuit configured to control a plurality of periods of transmission of the frequency-modulated continuous wave signal and, at each of said plurality of transmission periods, to keep constant a value of the integration frequency and to change a slope of the frequency modulation of the frequency-modulated continuous wave light signal.

According to an embodiment, after each integration period, the third circuit of each pixel is further configured to deliver an active detection signal if one and/or the other of the fifth or sixth signal is greater than the first voltage or smaller than the second voltage.

According to an embodiment, the first, second, and third circuits are configured so that, after each integration period, the detection signal is active:
if a difference between the first and third signals is, in absolute value, greater than the absolute value of the positive and negative thresholds; and/or
if a difference between the second and fourth signals is, in absolute value, greater than the absolute value of the positive and negative thresholds.

According to an embodiment:
the sensor comprises an address event readout circuit; and
each pixel comprises an output circuit configured to detect that the detection signal is active and to deliver, as a result of a detection that the detection signal is active, an address signal of the pixel to the address event readout circuit, the output circuit and the address event readout circuit being preferably configured to communicate with each other according to a handshake protocol.

According to an embodiment, the sensor comprises a control circuit configured to:
keep the integration frequency constant during an acquisition period; and
during the acquisition period, for an increasing integer index i ranging from 0 to N−1, with N a positive integer, and, for each value of index i, for a decreasing index u ranging from U to 0, with U a positive integer, control, for each pair of indices i and u, a period of transmission of the frequency-modulated continuous wave signal with a frequency modulation excursion equal to B0/(kⁱ·(2·u+1)), with B0 a frequency excursion value determined by an initial value of the distance to be detected and k is a positive resolution value, preferably only if, for q an integer ranging from 1 to U, logₖ(2·q+1) is different from i−j, with j an integer index ranging from 0 to i−1.

According to an embodiment, the sensor comprises a control circuit configured to keep a frequency modulation slope constant at each transmission period of an acquisition period; and during the acquisition period, for an increasing integer index i ranging from 0 to N−1, with N a positive integer, and, for each value of index i, for a decreasing index u ranging from U to 0, with U a positive integer, to control, for each pair of indices i and u, a period of transmission of the frequency-modulated continuous wave signal and a value of the integration frequency equal to kⁱ·fs0/(2·u+1) with fs0 an integration frequency value determined by an initial value of the distance to be detected and k a positive resolution value, preferably only if, for q, an integer ranging from 1 to U, log (1/(2·q+1)) is different from i−j, with j an integer index ranging from 0 to i−1.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 schematically and in the form of blocks, an example of an embodiment of a pixel;

FIG. 2 illustrates, in a timing diagram, an operation of a circuit of the pixel of FIG. 1;

FIG. 3 illustrates, by means of curves, the operation of another circuit of the pixel of FIG. 1;

FIG. 4 shows an example of implementation of the pixel of FIG. 1;

FIG. 5 illustrates in timing diagrams an operation of the pixel of FIG. 4;

FIG. 6 shows another example of implementation of two circuits of the pixel of FIG. 4;

FIG. 7 shows another example of implementation of a circuit of the pixel of FIG. 4;

FIG. 8 shows another example of implementation of a circuit of the pixel of FIG. 1;

FIG. 9 shows another example of implementation of a circuit of the pixel of FIG. 1;

FIG. 10 shows still another example of implementation of a circuit of the pixel of FIG. 1;

FIG. 11 illustrates, in timing diagrams, an operation of an optoelectronic system comprising the pixel of FIG. 1;

FIG. 12 illustrates, in timing diagrams, another example of operation of an optoelectronic system comprising the pixel of FIG. 1;

FIG. 13 illustrates, in timing diagrams, still another example of operation of an optoelectronic system comprising the pixel of FIG. 1;

FIG. 14 illustrates, in timing diagrams, still another example of operation of an optoelectronic system comprising the pixel of FIG. 1;

FIG. 15 illustrates, in timing diagrams, still another example of operation of an optoelectronic system comprising the pixel of FIG. 1;

FIG. 16 illustrates, in timing diagrams, still another example of operation of an optoelectronic system comprising the pixel of FIG. 1; and

FIG. 17 illustrates an example of implementation of a circuit of the pixel of FIG. 1.

### DESCRIPTION OF EMBODIMENTS

The same elements have been designated by the same references in the various figures. In particular, structural and/or functional elements common to the different embodiments may have the same references and may have identical structural, dimensional and material properties.

For the sake of clarity, only those steps and elements that are useful for understanding the described embodiments have been shown and are described in detail.

Unless specified otherwise, when reference is made to elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings or to a . . . in a normal position of use.

Unless specified otherwise, the expressions “about”, “approximately”, “substantially”, and “in the order of” signify plus or minus 10% or 10°, preferably of plus or minus 5% or 5°.

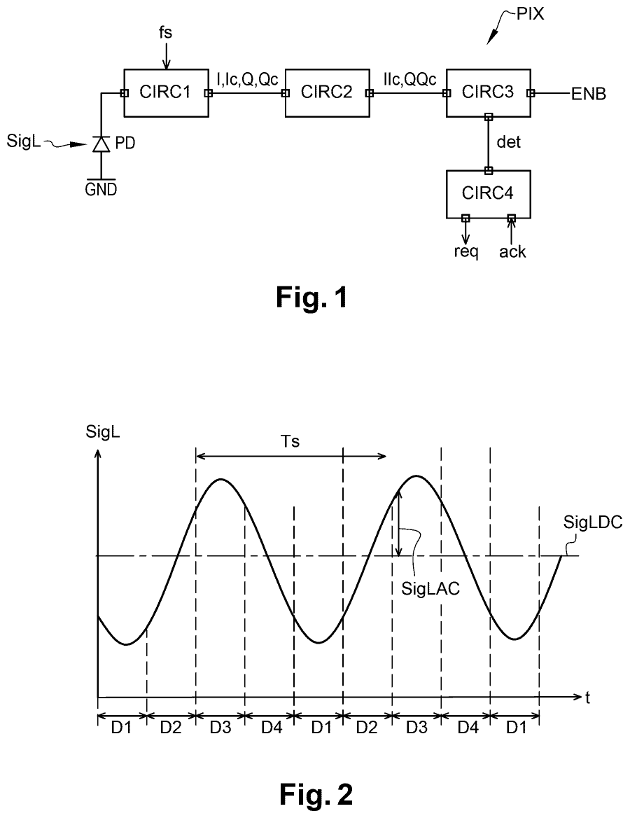

FIG. 1 shows, schematically and in the form of blocks, an example of an embodiment of a pixel PIX. Although this is not illustrated in FIG. 1, this pixel PIX may form part of an array of pixels PIX of a distance sensor.

Pixel PIX comprises at least one photodetector PD, for example at least one photodiode. In the example of FIG. 1, pixel PIX comprises a single photodetector PD.

Each photodetector PD of pixel PIX is configured to receive a light signal sigL. Signal sigL corresponds to a superposition of part of a frequency-modulated continuous wave light signal and of another part of the frequency-modulated continuous wave light signal having been emitted toward a scene and reflected by a point in the scene associated with pixel PIX before reaching this pixel PIX. Signal sigL thus has a beat frequency fR determined at least partly by the distance z between pixel PIX and the point in the scene associated with pixel PIX. For example, the beat frequency is determined by the distance z and by the distance traveled by the reference part of the light signal which is directly sent to the pixel, from the optical device separating the light signal into two parts until this reference part is superimposed to the part of the light signal coming from a reflection on the scene to be imaged. For example, since the distance traveled by the reference part of the optical signal is very small as compared with distance z, the latter is negligible as compared with distance z and the beat frequency is then considered as entirely determined by distance z.

Although this is not illustrated in FIG. 1, in practice pixel PIX forms part of an optoelectronic system, for example called a distance sensor, comprising a coherent light source, for example a laser source, configured to deliver a first frequency-modulated continuous wave light signal. More particularly, the first signal has its frequency fL which varies continuously and linearly (or substantially linearly) over a frequency range of extent B, B also being referred to as the amplitude or excursion of the frequency modulation. This frequency modulation of the first signal is continuous and linear (or substantially linear) all throughout a period T during which the first signal is emitted by the source, that is, throughout the entire duration T of the transmission period (or duration). Thus, the slope of the frequency modulation of the first light signal is equal to B/T.

Further, although this is not illustrated in FIG. 1, the optoelectronic system or sensor comprising pixel PIX and the coherent light source emitting the first light signal comprises an optical device. The optical device is configured to separate the first signal into a second signal and a third signal, to transmit the second signal towards a scene, and to supply the third signal, also called reference signal, to pixel PIX, that is, to the photodetector(s) of pixel PIX. At pixel PIX, the third signal is superimposed to a signal corresponding to the reflection by the scene of the second signal, for example by means of another optical device, and signal sigL corresponds to this superposition of two light signals.

Thus, the frequency fR of signal sigL is entirely determined by the slope B/T of the frequency modulation for this transmission period and by the distance z at which the point in the scene associated with the pixel is located during this transmission period.

Pixel PIX comprises a circuit CIRC1. Circuit CIRC1 is coupled, for example connected, to each photodetector PD of pixel PIX. As an example, each photodetector of pixel PIX has an electrode, for example its anode, connected to a reference potential, for example ground GND, and another electrode, for example its cathode, coupled, preferably connected, to circuit CIRC1, that is, to a corresponding input of circuit CIRC1.

At each transmission period, pixel PIX, and more specifically its circuit CIRC1, are configured to implement a corresponding integration period of signal sigL, or, more simply, a corresponding integration of signal sigL.

At each integration period of signal sigL, circuit CIRC1 is configured to deliver, at the end of integration periods (or durations), four signals I, Ic, Q, and Qc. These signals may be supplied simultaneously and/or sequentially to a circuit CIRC2 of pixel PIX, as will be illustrated hereafter in relation with examples of implementations of circuit CIRC1. As an example, each integration period (or duration) has a duration equal to the corresponding duration T of transmission of light signal FMCW.

More particularly, circuit CIRC1 is configured so that signal I is representative of, or determined by, a quantity of charges photogenerated in one of the photodetectors of pixel PIX (in the single photodetector PD in the example of FIG. 1) during time periods D1 of the integration period. Time periods D1 are periodic and are repeated at a frequency fs called integration frequency.

Similarly, circuit CIRC1 is configured so that signal Q is representative of, or determined by, a quantity of charges photogenerated in one of the photodetectors of pixel PIX (in the single photodetector PD, in the example of FIG. 1) for time periods D2 of the integration period. Durations D2 are, like durations D1, periodic at frequency fs. Further, a duration of each time period D2 is equal to a duration of each time period D1. In other words, time periods D1 and D2 each have a same duration. Durations D2 are phase-shifted by Π/2 with respect to durations D1.

Circuit CIRC1 is further configured so that signal Ic is representative of, or determined by, a quantity of charges photogenerated in one of the photodetectors of pixel PIX (in the single photodetector PD in the example of FIG. 1) during time periods D3 of the integration period. Time periods D3 are, like time periods D1 and D2, periodic at frequency fs. Further, time periods D1, D2, and D3 each have a same duration. Time periods D3 are phase-shifted by II with respect to time periods D1.

Finally, circuit CIRC1 is configured so that signal Qc is representative of, or determined by, a quantity of charges photogenerated in one of the photodetectors of pixel PIX (in the single photodetector PD in the example of FIG. 1) during time periods D4 of the integration period. Time periods D4 are, like time periods D1, D2, and D3, periodic at frequency fs. Further, time periods D1, D2, D3, and D4 each have a same duration. Time periods D4 are phase-shifted by 3·Π/2 with respect to time periods D1.

Thus, circuit CIRC1 integrates, at integration frequency fs, the charges photogenerated in pixel PIX by signal sigL according to four channels, or phases, delivering the respective signals I, Ic, Q, and Qc corresponding to the respective time periods D1, D3, D2, and D4. The four channels delivering the respective signals I, Ic, Q, and Qc are, for example, called in-phase channel, complementary in-phase channel, quadrature channel, and complementary quadrature channel.

Circuit CIRC1 thus receives signals for controlling durations D1, D2, D3, and D4, these control signals being clocked at frequency fs.

FIG. 2 illustrates, in a timing diagram, an operation of the circuit CIRC1 of the pixel PIX of FIG. 1.

In this example, integration frequency fs is equal to the beat frequency fR of signal sigL.

Further, in this example where pixel PIX comprises a single photodetector PD, time periods D1, D2, D3, and D4 have, for example, a duration equal to Ts/4, with Ts the repetition period of time periods D1, D2, D3, and D4, which is equal to 1/fs.

As can be seen in FIG. 2, signal sigL comprises a DC component sigLDC and an AC component sigLAC (the component sigLDC and the envelope of signal sigL are schematically shown in FIG. 2). The useful part of signal sigL is its AC component sigLAC.

Returning to FIG. 1, as previously indicated, circuit CIRC2 receives signals I, Q, Ic, and Qc after each period of integration of the photogenerated charges by signal sigL in pixel PIX.

Circuit CIRC2 is configured to suppress the influence of DC component sigLDC in signals I, Q, Ic, and Qc. For this purpose, circuit CIRC2 is configured to deliver signals IIc and QQc. More particularly, signal IIc is determined by the difference between signals I and Ic, signal QQc being determined by the difference between signals Q and Qc. For example, signal IIc is determined by difference I−Ic (or Ic−I) and signal QQc is determined by difference Q−Qc (or Qc−Q). For example, signal IIc is equal to difference I−Ic (or Ic−I) plus a fixed offset VCL, signal QQc being equal to difference Q−Qc (or Qc−Q) plus the fixed offset VCL.

According to an embodiment, circuit CIRC2 comprises a capacitive element having a first electrode selectively coupled to a DC potential VCL. As an example, potential VCL may be any fixed potential and is, for example, a zero potential.

Circuit CIRC2 is then configured to apply a signal determined by signal I to a second electrode of the capacitive element while the first electrode is coupled to potential VCL and thus is at a potential at least partly determined by potential VCL, and then to apply another signal determined by signal Ic to the second electrode of the capacitive element while the first electrode is decoupled from potential VCL, or, in other words, left floating. As a result, at the end of these two operations, a voltage on the first floating electrode of the capacitor is determined by difference I-Ic and by potential VCL. This voltage then corresponds to signal IIc.

Similarly, circuit CIRC2 is configured to apply a signal determined by signal Q to a second electrode of another capacitive element while the first electrode of this other capacitive element is coupled to potential VCL and thus is at a potential at least partly determined by potential VCL, and then to apply another signal determined by signal Qc to the second electrode of this other capacitive element while the first electrode of this other capacitive element is left floating, so that, at the end of these two operations, a voltage on the first floating electrode of this other capacitive element is determined by difference Q-Qc and by potential VCL and corresponds to signal QQc.

As a variant, rather than providing another capacitive element to generate signal QQc, this signal may be generated by using the same capacitive element as that used to generate signal IIc, signals IIc and QQc then being generated sequentially by circuit CIRC2.

Signals IIc and QQc are supplied to a circuit CIRC3 of pixel PIX.

As an example, the two signals IIc and QQc are simultaneously supplied to circuit CIRC3, for example when circuit CIRC2 comprises a capacitive element for generating signal IIc and another capacitive element for generating signal QQc and the two signals IIc and QQc are generated in parallel by circuit CIRC2.

As an alternative example, the two signals are supplied one after the other to circuit CIRC3, for example when circuit CIRC2 comprises a single capacitive element for generating signal IIc, and then signal QQc (or vice versa).

Circuit CIRC3 is configured to compare the difference between signals I and Ic with two thresholds VTH+ and VTH−, having opposite signs but a same absolute value. For example, threshold VTH+ is positive, threshold VTH-being negative. For this purpose, circuit CIRC3 compares signal IIc with a voltage V+ determined by threshold VTH+ and with a voltage V− determined by threshold VTH−. For example, voltage V+ is determined by threshold VTH+ and potential VCL, voltage V− being determined by threshold VTH− and potential VCL. For example, voltage V+ is equal to VCL+VTH+ and voltage V—is equal to VCL+VTH−. Circuit CIRC3 is further configured to compare the difference between signals Q and Qc with the two thresholds VTH+ and VTH−. For this purpose, circuit CIRC3 compares signal QQc with voltages V+ and V−. According to an embodiment, circuit CIRC3 comprises at least one comparator, and the four above-described comparisons are implemented by this or these comparators of circuit CIRC3.

According to an embodiment, thresholds VTH+ and VTH—are determined (or predetermined) so that the difference between signals I and Ic is greater than VTH+ or smaller than VTH−, and/or the difference between signals Q and Qc is greater than VTH+ or smaller than VTH−, when the frequency fR of signal sigL is equal to integration frequency fs. In other words, the absolute value of thresholds VTH+ and VTH− is determined (or predetermined) so that the absolute value of one and/or the other of the differences between signals I and Ic and between signals Q and Qc is greater than the absolute value of thresholds VTH+ and VTH-when the beat frequency fR of signal sigL is equal to integration frequency fs. Still in other words, thresholds VTH+ and VTH—are determined (or predetermined) so that when one and/or the other of signals IIc and QQc is greater than voltage V+, and/or smaller than voltage V−, this means that the signal sigL received by pixel PIX has a beat frequency fR equal to integration frequency fs. As an example, thresholds VTH+ and VTH− are determined during the design of the optoelectronic system, or sensor, comprising pixel PIX. As an alternative example, thresholds VTH+ and VTH− are determined internally within the optoelectronic system, or sensor, comprising pixel PIX, for example are adapted according to the current transmission period.

As an example, those skilled in the art will be capable of determining the absolute value of thresholds VTH+ and VTH−, for example during a calibration phase or empirically.

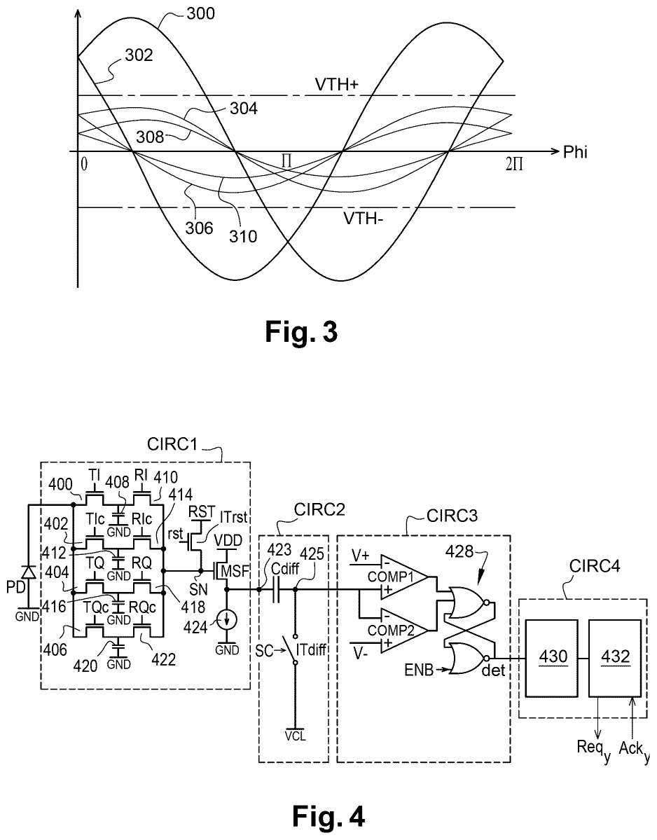

FIG. 3 illustrates by means of curves an operation of the circuit CIRC3 of the pixel PIX of FIG. 1.

More specifically, FIG. 3 illustrates:
by means of curves 300 and 302 the variation respectively of the difference between signals I and Ic and of the difference between signals Q and Qc as a function of the phase Phi between the signal at frequency fs and the signal at frequency fR when fR is equal to fs, or, in other words, as a function of the phase Phi between the signal reflected by the scene and the reference signal,
by means of curves 304 and 306, the variation respectively of the difference between signals I and Ic and the difference between signals Q and Qc as a function of the phase Phi between the signal at frequency fs and the signal at frequency fR when fR is equal to 3 times frequency fs, and
by means of curves 308 and 310, the variation of the difference between signals I and Ic and of the difference between signals Q and Qc as a function of the phase Phi between the signal at frequency fs and the signal at frequency fR when fR is equal to 5 times frequency fs.

Further, although this is not shown in FIG. 3, the difference between signals I and Ic and the difference between signals Q and Qc each have a value of zero or almost zero, regardless of phase Phi when frequency fR is equal to 1.001*fs or to 0.99*fs.

Thus, FIG. 3 shows that, regardless of phase Phi, the difference between signals I and Ic and/or the difference between signals Q and Qc are, in absolute value, greater than the absolute value of thresholds VTH+ and VTH-only when beat frequency fR is equal to integration frequency fs.

Returning to FIG. 1, according to an embodiment, the circuit CIRC 3 of pixel PIX is configured to deliver a detection signal det indicating whether or not the difference between signals I and Ic and/or the difference between signals Q and Qc are, in absolute value, greater than the absolute value of thresholds VTH+ and VTH−. For example, signal det is active when one and/or the other of signals IIc and QQc is greater than voltage V+ or smaller than voltage V−. In other words, signal det is in the active state if:
signal IIc is greater than voltage V+ or smaller than voltage V−; and/or
signal QQc is greater than voltage V+ or smaller than voltage V−.

Preferably, the active or inactive state of signal det is valid only when a signal ENB is active.

According to an embodiment, pixel PIX comprises an output circuit CIRC4. Circuit CIRC4 receives signal det from circuit CIRC3.

Circuit CIRC4 is configured to deliver, to a readout circuit of a system comprising pixel PIX, for example to a readout circuit of a sensor comprising an array of pixels PIX, an indication that pixel PIX has received a signal sigL at frequency fR equal to fs for a given integration period, that is, for a given period of transmission of signal FMCW.

For example, circuit CIRC4 is configured to implement, with the readout circuit of the system comprising pixel PIX, an event-driven readout of pixel PIX. For example, circuit CIRC4 is configured to supply, to the readout circuit of the system, a signal req indicating the address of pixel PIX when signal det is active. More particularly, circuit CIRC4 delivers the address signal req of pixel PIX as soon as signal det becomes active and as long as the readout circuit does not supply an acknowledgement signal ack to circuit CIRC4. The signal ack delivered by the readout circuit indicates to circuit CIRC4 that the readout circuit has correctly received the information that pixel PIX has detected a signal sigL at a frequency fR equal to fs.

As an alternative example, circuit CIRC4 is configured to implement, with the readout circuit of the system comprising pixel PIX, a reading of pixel PIX during which circuit CIRC4 indicates to the readout circuit of the system whether or not pixel PIX has detected a signal sigL at frequency fR equal to fs during one or more last integration periods, only when the readout circuit interrogates (or selects or reads) the circuit CIRC4 of pixel PIX. As an example, in a sensor comprising an array of pixels PIX, this allows the implementation of a sequential reading of the pixels PIX of the array, for example a row-by-row reading.

According to an embodiment, a sensor comprising one or more pixels PIX, for example an array of pixels PIX, and further comprising a control circuit configured to control a plurality of periods of transmission of signal FMCW by a coherent light source of the sensor, is provided. As an example, this control circuit is configured to control, for each period of transmission of signal FMCW, the value of the slope B/T of the frequency modulation of the signal FMCW emitted by the light source and/or the value of integration frequency fs.

According to an embodiment, the control circuit is configured to keep slope B/T constant during a plurality of periods of transmission of signal FMCW and, at each of this plurality of transmission periods, to modify the value of integration frequency fs. Thus, each of this plurality of transmission periods will enable to detect a different distance from the sensor to a scene.

For example, if a first transmission period is performed with a value A0 of ratio 2·B/(c·T), and frequency fs has a value f0, then a pixel PIX will deliver, at the end of a corresponding integration period, a signal det active when this pixel is at a distance z0=f0/A0 from the point in the scene associated with this pixel. Further, if a second transmission period is performed with the same value A0 of ratio 2·B/(c·T) but with a frequency fs having a value f1, then pixel PIX will deliver, at the end of the corresponding integration period, a signal det active when this pixel is at a distance z1=f1/A0 from the point in the scene associated with this pixel.

According to an alternative embodiment, the control circuit is configured to maintain frequency fs constant for a plurality of periods of transmission of the frequency-modulated continuous wave light signal and, at each of this plurality of transmission periods, to modify the modulation slope B/T of the transmitted light signal. Thus, each of this plurality of transmission periods will enable to detect a different distance from the sensor to a scene.

For example, if a first transmission period is performed with a value A0 of ratio 2·B/(c·T), and integration frequency fs has a value f0, then a pixel PIX will deliver, at the end of a corresponding integration period, an active signal det when this pixel is at a distance z0=f0/A0 from the point in the scene associated with this pixel. Further, if a second transmission period is performed with the same value f0 of integration frequency fs, but with a value A1 for ratio 2·B/(c·T), then pixel PIX will deliver, at the end of the corresponding integration period, a signal det active when this pixel is at a distance z1=f0/A1 from the point in the scene associated with this pixel.

In pixel PIX, circuit CIRC3 compares each of signals IIc and QQc with voltages V+ and V− to compare the absolute value of the difference between signals I and Ic with the absolute value of thresholds VTH+ and VTH− and the absolute value of the difference between signals Q and Qc with the absolute value of thresholds VTH+ and VTH−. One might have thought of replacing circuit CIRC3 with a circuit configured to calculate the root mean square of the difference between signals I and Ic and the difference between signals Q and Qc, and to compare the calculated root mean square of the average with a threshold VTHmq. The calculated root mean square would then have been greater than threshold VTHmq when the frequency fR of signal sigL would have been equal to integration frequency fs.

However, this would have required a circuit more complex than circuit CIRC3 and more bulky than circuit CIRC3, which is not desirable, for example in a sensor comprising an array of pixels PIX.

Further, the root mean square calculation implemented by such a circuit would have been slower than the implementation of the comparisons of signals IIc and QQc with voltages V+ and V−. For example, the root mean square calculation time would not have been compatible with video stream capture applications, while pixel PIX is adapted to such applications.

FIG. 4 shows an example of implementation of the pixel PIX of FIG. 1.

In the embodiment of FIG. 4, pixel PIX comprises a single photodetector PD.

In the embodiment of FIG. 4, regardless of the fact that pixel PIX comprises a single photodetector PD, circuit CIRC1 is a circuit operating in the charge domain. Photodetector PD is then preferably a pinned photodiode.

In the embodiment of FIG. 4, regardless of the fact that pixel PIX comprises a single photodetector PD and of the fact that circuit CIRC1 operates in the charge domain, circuit CIRC2 comprises a single capacitor for generating signals IIc and QQc.

In the embodiment of FIG. 4, regardless of the fact that pixel PIX comprises a single photodetector PD, that circuit CIRC1 operates in the charge domain, and that circuit CIRC2 comprises a single capacitor for generating signals IIc and QQc, circuit CIRC3 comprises two comparators for implementing comparisons of signals IIc and QQc at voltages V+ and V−.

More particularly, in the embodiment of FIG. 4, circuit CIRC1 comprises four transfer gates 400, 402, 404, and 406, each having a conduction terminal connected to photodetector PD.

Gate 400 has its second conduction terminal connected to a memory 408, for example shown in the form of a capacitive element in FIG. 4. Further, a control terminal of gate 400 receives a control signal TI. Memory 408 is coupled to a sense node SN of circuit CIRC1 by a transfer gate 410 controlled by a signal RI.

Gate 402 has its second conduction terminal connected to a memory 412, for example shown in the form of a capacitive element in FIG. 4. In addition, a control terminal of gate 402 receives a control signal TIc. Memory 412 is coupled to sense node SN by a transfer gate 414 controlled by a signal RIc.

Gate 404 has its second conduction terminal connected to a memory 416, for example shown in the form of a capacitive element in FIG. 4. In addition, a control terminal of gate 404 receives a control signal TQ. Memory 416 is coupled to sense node SN by a transfer gate 418 controlled by a signal RQ.

Gate 406 has its second conduction terminal connected to a memory 420, for example shown in the form of a capacitive element in FIG. 4. In addition, a control terminal of gate 406 receives a control signal TQc. Memory 420 is coupled to sense node SN by a transfer gate 422 controlled by a signal RQc.

Signals TI, TQ, TIc, and TQc are periodic at frequency fs and allow the implementation of the respective integration time periods D1, D2, D3, and D4.

Circuit CIRC1 further comprises a switch ITrst controlled by a signal rst. Switch ITrst is connected between node SN and a DC reset potential RST. When switch ITrst is switched to the on state, the potential on node SN is initialized to potential RST.

Circuit CIRC1 further comprises a MOS (metal oxide semiconductor) transistor designated with reference MSF in FIG. 4. Transistor MSF has its gate coupled, for example connected, to node SN. Transistor MSF is coupled in series with a current source 424 configured to supply a bias current to the transistor, between a power supply potential VDD and reference potential GND. In this example, potential VDD is referenced to potential GND and is positive, current source 424 is connected between the source of transistor MSF and potential GND, and the drain of transistor MSF is coupled, for example connected, to potential VDD. Transistor MSF then is an N-channel MOS transistor. However, in other examples not shown, transistor MSF may be replaced with a P-channel MOS transistor, for example when current source 424 is connected between the source of transistor MSF and potential VDD, and the drain of transistor MSF is coupled, preferably connected, to potential GND.

In this example, transistor MSF is configured to supply signals I, Ic, Q, and Qc sequentially to its source.

In the embodiment of FIG. 4, circuit CIRC2 comprises a capacitive element Cdiff. A first electrode 423 of capacitive element Cdiff is coupled, for example connected, to the output of circuit CIRC1, that is, to the source of transistor MSF in this example. A second electrode 425 of capacitive element Cdiff is selectively coupled to a DC potential VCL by a switch ITdiff. In the example of FIG. 4, switch ITdiff is connected between potential VCL and electrode 425.

The second electrode 425 of capacitive element Cdiff forms, in this example, the output of circuit CIRC2 delivering signals IIc and QQc. In this example, signals IIc and QQc are delivered sequentially.

In the embodiment of FIG. 4, circuit CIRC3 comprises two comparators COMP1 and COMP2. Comparator COMP1 is configured to compare the signal IIc or QQc that it receives with voltage V+. Comparator COMP2 is configured to compare the signal IIc or QQc that it receives with voltage V−.

As an example, the outputs of the comparators are supplied to a circuit 428 of circuit CIRC3. Circuit 428 is controlled by an enable circuit ENB. Circuit 428 is configured to receive the binary outputs of comparators COMP1 and COMP2 and to deliver, when signal ENB is active, signal det in the active state if one or the other of comparators COMP1 and COMP2 indicates that the signal IIc or QQc that it receives is greater than VTH+ or smaller than VTH−. As an example, the active or inactive state of signal det is then valid when signal ENB is active.

As an example, circuit 428 comprises two NOR gates. One NOR gate has an input coupled to the output of comparator COMP1, an input coupled to the output of comparator COMP2, and an input connected to the output of the second NOR gate. The second NOR gate has an input connected to the output of the first NOR gate, an input receiving signal ENB, and its output delivering signal det.

As an alternative example, circuit 428 is omitted, and signal ENB is supplied to comparators COMP1 and COMP2, so that the outputs of the comparators are only updated when signal ENB is active. In other words, comparators COMP1 and COMP2 are then comparators latched on signal ENB. A logic circuit is for example provided to deliver signal det from the outputs of comparators COMP1 and COMP2. As an example, the active or inactive state of signal det is then valid when signal ENB is active. As an example, in the example of FIG. 4, the logic circuit delivering signal det from the outputs of the comparators is an OR logic gate, although in other examples where the high and low levels of the outputs of the comparator are inverted, this logic circuit may be an AND logic gate.

As another alternative example, comparators COMP1 and COMP2 may be replaced by a single comparator.

For example, in a case with a single comparator, during a phase of comparison of signal IIc with V+, one of the two inputs of this single comparator receives signal IIc, and the other of the two inputs of the single comparator receives voltage V+. Then, during a phase of comparison of signal IIc to V−, one of the two inputs of the single comparator receives signal IIc and the other of the two inputs of the single comparator receives voltage V−. The comparison of signal QQc with voltages V+ and V− is implemented similarly to what is described hereabove and is within the abilities of those skilled in the art based on the description made hereabove.

As an example, in FIG. 4, pixel PIX comprises circuit CIRC4 and the latter is configured to implement an event-driven reading. For example, circuit CIRC4 comprises a circuit 430 configured to detect an active state of signal det and a circuit 432 coupled to the output of circuit 430 and configured to supply the address of the pixel to a readout circuit of AER (“Address Event Readout”) type, not shown in FIG. 4, when circuit 430 detects an active state of signal det. Preferably, circuit CIRC4 and the readout circuit then communicate with each other according to a “handshake” protocol. The handshake protocol for the event-driven images sensors (or event-driven imagers) is known. For example, the article “A Biomorphic Digital Image Sensor” by E. Culurciello et al., published in IEEE journal of solid-state circuits, vol. 38, No. 2, February 2023, describes this type of reading intended for detecting variations in light intensity in a pixel of the imager. This pixel provides a request to a decoding system based on an AER arbitration tree, which generates the pixel address while avoiding collisions during simultaneous requests by several pixels of the imager. As another example, the article “An asynchronous hybrid pixel image sensor” by M. Akrarai et al., 27th IEEE International Symposium on Asynchronous Circuits and System (ASYNC), 2021, uses the same “handshake” protocol, but without the arbitration tree, which is too large and has a significant latency delay. As another example, U.S. Pat. No. 11,889,208 proposes another alternative architecture still based on the handshake protocol, but again without an AER tree and with accelerated reading. It is for example this architecture that will be implemented in an event-driven imager comprising a plurality of pixels PIX, for example a plurality of pixels PIX as described in relation to FIG. 4.

Note that, in the state of the art, the “handshake” protocol is used for “true” events, i.e. to read random phenomena (light variation, arrival of a photon, etc.). In the present description, this “handshake” protocol allows a reading method with additional functionalities compared to the usual sequential readings of image sensors. For example, in a two-dimensional image sensor, the use of a reading based on a “handshake” protocol makes it possible to obtain a large dynamic range, as described in document WO 2023126424. For example, in the case of an imager comprising a plurality of pixels PIX and enabling a depth image to be obtained, the use of the “handshake” protocol for reading the pixels PIX advantageously enables a pixel to be deactivated once it has been read after sending a request to the reading circuit of the imager, the pixel remaining deactivated until the start of the next acquisition period Tac, to avoid redundancies.

Although this is not shown in FIG. 4, in practice pixel PIX comprises a control circuit configured to supply it with all its control signals. This control circuit is, for example, shared by a plurality of pixels PIX, for example by all the pixels PIX, of a sensor comprising a plurality of pixels PIX.

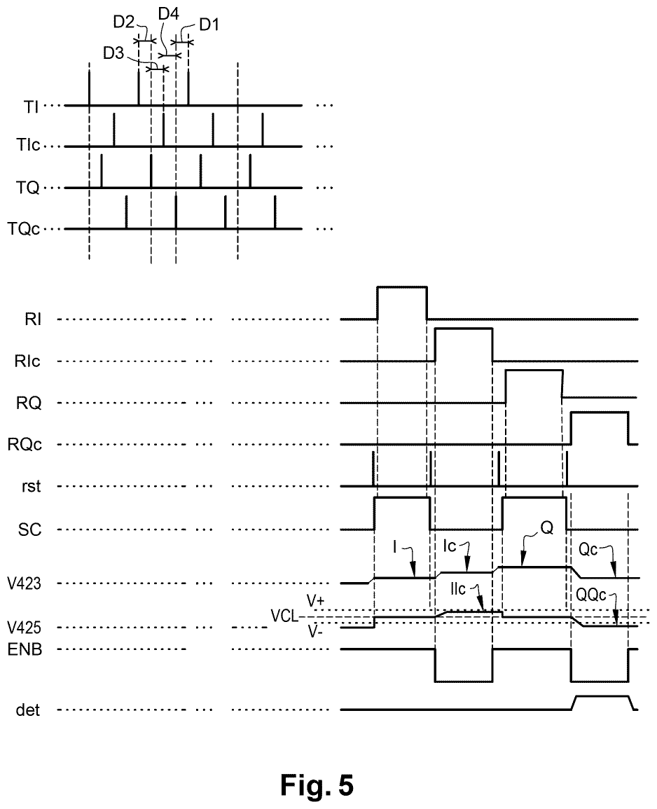

FIG. 5 illustrates, by means of timing diagrams, an example of operation of the pixel PIX of FIG. 4.

In this example, gates 400, 402, 404, 406, 410, 414, 418, and 422 are conductive when their respective control signals TI, TIc, TQ, TQc, RI, RIc, RQ, and RQc are in the high state. Further, in this example, switch ITdiff is controlled by a signal SC and is on when signal SC is in the high state. In the timing diagrams of FIG. 5, the voltage at electrode 423 and 425 is designated with reference V423, respectively V425. In this example, the output det of circuit 428 is updated from the outputs of comparators COMP1 and COMP2 when signal ENB is active, the active state of signal ENB being, in this example, the low state of signal ENB.

FIG. 5 illustrates the course of signals TI, TIc, TQ, TQc, RI, RIc, RQ, RQc, rst, SC, V423, V425, ENB, and det.

As illustrated by signals TI, TIc, TQ, and TQc, during an integration period, gates 400, 402, 404, and 406 are periodically set to the conductive state, at frequency fs, but with phase shifts between them, so that, at the end of the integration period, the charges transferred from photosensitive element PD to the respective memories 408, 412, 416, and 420 correspond to the charges photogenerated in element PD during the respective time periods D1, D3, D2, and D4 of the integration period. By way of illustration, a time period D1, a time period D2, a time period D3, and a time period D4 are referenced in FIG. 5.

At the end of the integration period, memories 408, 412, 416, and 420 are read one after the other by switching gates 410, 414, 418, and 422 to the conductive state one after the other.

Before each setting to the conductive state of gate 410, 414, 418, or 422, node SN is reset by switching switch ITrst to the on state.

In the example of FIG. 5, memory 408 is read first (signal RI in the high state) and voltage V423 then corresponds to signal I and is at a value determined by the charges photogenerated in pixel PIX during time periods D1. During the reading of memory 408, switch ITdiff is in the on state, whereby voltage V425 is equal to potential VCL. Then, switch ITdiff is switched to the off state, and memory 412 is read (RIc in the high state). During the reading of memory 412, voltage V423 corresponds to signal Ic and is at a value determined by the charges photogenerated in pixel PIX during time periods D3. Further, during the reading of memory 412, since switch ITdiff is off and electrode 425 is floating, the application of voltage Ic to electrode 423 results in that the voltage V425 on electrode 425 is then equal to IIc, and, more particularly in this example, to Ic−I+VCL. While memory 412 is being read, signal ENB is switched to the active state (low state in the example of FIG. 5), and signal det is updated from the outputs of comparators COMP1 and COMP2. As in the example of FIG. 5, voltage IIc is lower than V+ and higher than V−, signal det remains in the inactive state, that is, in the low state in the example of FIG. 5.

In the example of FIG. 5, after circuit CIRC1 has successively supplied signals I and Ic to circuit CIRC2, CIRC2 circuit has supplied signal IIc to circuit CIRC3, and circuit CIRC3 has compared signal IIc with voltages V+ and V− and updated signal det accordingly, memory 416 is read from (signal RQ in the high state). During the reading from memory 416, voltage V423 corresponds to signal Q and is at a value determined by the charges photogenerated in pixel PIX during time periods D2. During the reading from memory 416, switch ITdiff is in the on state, whereby voltage V425 is equal to potential VCL. Then, switch ITdiff is switched to the off state, and memory 420 is read (RQc in the high state). During the reading from memory 420, voltage V423 corresponds to signal Qc and is at a value determined by the charges photogenerated in pixel PIX during time periods D4. Further, during the reading from memory 420, since switch ITdiff is off and electrode 425 is floating, the application of voltage Qc to electrode 423 results in that the voltage V425 on electrode 425 is then equal to QQc, and, more specifically in this example, to Qc Q+VLC. While memory 420 is being read from, signal ENB is switched to the active state, and signal det is updated from the outputs of comparators COMP1 and COMP2. As in the example of FIG. 5, voltage QQc is lower than V−, signal det is switched to the active state, that is, the high state in the example of FIG. 5. Thus, during the above-described steps, circuit CIRC1 successively supplies signals Q and Qc to circuit CIRC2, circuit CIRC2 supplies signal QQc to circuit CIRC3, and circuit CIRC3 compares signal QQc with voltages V+ and V− and updates signal det accordingly.

It should be noted that the order in which memories 408 and 412 are read may be reversed, that the order in which memories 416 and 410 are read may be reversed, and that the reading of memories 416 and 420 may be implemented before the reading of memories 408 and 412 without for this to alter the detection that one and/or the other of signals IIc and QQc is greater than voltage V+ or smaller than voltage V−.

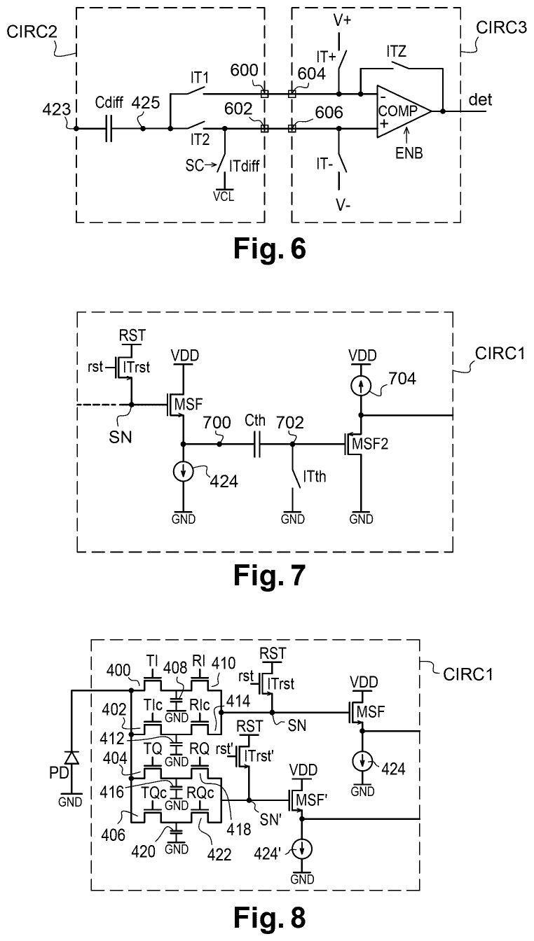

FIG. 6 illustrates another example of implementation of the circuits CIRC2 and CIRC3 of the pixel PIX of FIG. 4.

In this example, circuit CIRC3 comprises a single comparator COMP.

Further, in this example, circuits CIRC2 and CIRC3 are configured to implement a calibration of the single comparator COMP of circuit CIRC3 so as to suppress, during comparisons of signal IIc with voltages V+ and V−, and of signal QQc with voltages V+ and V−, the input offset Voff of comparator COMP.

As an example, the calibration of comparator COMP may be implemented as follows.

As compared with the circuit CIRC2 of FIG. 4, the circuit CIRC2 of FIG. 6 comprises two outputs 600 and 602, and two switches IT1 and IT2. The electrode 425 of capacitor Cdiff is coupled to output 600 by switch IT1 and to output 602 by switch IT2. Output 602 is further coupled to potential VCL by switch ITdiff. Circuit CIRC3 comprises two inputs 604 and 606 corresponding to the inputs, for example respectively inverting (−) and non-inverting (+), of comparator COMP. Input 604 is connected to output 600, and input 604 is connected to output 602. Comparator COMP is controlled by signal ENB, so that its output det is only updated from its inputs when signal ENB is in the active state. Circuit CIRC3 further comprises a switch ITZ connected between the output of comparator COMP and the inverting input (−) of comparator COMP. A switch IT+ couples the inverting input (−) of comparator COMP to voltage V+, and a switch IT-couples the non-inverting (+) input of comparator COMP to voltage V−.

The operation of circuits CIRC2 and CIRC3 is, for example, as follows during the comparison of signal IIc with voltages V+ and V−, that is, during the comparison of the absolute value of thresholds VTH+ and VTH− with the absolute value of the difference between signals I and Ic.

In a first step, switches ITZ, ITdiff, and IT1 are on, the other switches being on. Signal I is then applied to the electrode 423 of capacitor Cdiff, which here corresponds to the input of circuit CIRC2. As a result:
voltage V423 is equal to voltage I,
the non-inverting input of comparator COMP receives potential VCL (ITdiff on),
the inverting input of comparator COMP and thus voltage V425 are at a potential equal to VCL+ Voff due to the fact that comparator COMP operates as a follower (ITZ off), with Voff the input offset voltage of comparator COMP. Voltage Voff is a voltage offset which is present on the inverting input of comparator COMP with respect to its non-inverting input. More specifically, during this first step, the electrode 425 of capacitive element Cdiff is coupled to potential VCL by on switch IT1, comparator COMP, and its on switch ITZ, and on switch ITdiff, and the voltage at electrode 425 is thus equal to VCL+Voff.

In a second step, switches ITZ and ITdiff are switched to the off state, after which signal Ic is applied to the electrode 423 of capacitive element Cdiff. As a result:
the electrode 425 of capacitive element Cdiff is decoupled from potential VCL and is floating, voltage V423 is equal to voltage Ic, and voltage V425 is then equal to IIc, that is, Ic−I+VCL+Voff in this example.

In a third step, switch IT− is switched to the on state. In this third step, electrode 425 of capacitor Cdiff is floating. As a result:
the non-inverting input of comparator COMP receives voltage V-equal to VCL+VTH− in this example, VTH-being negative,
the inverting input of comparator COMP receives signal IIc equal to Ic−I+VCL+Voff in this example, and
comparator COMP implements the comparison of its non-inverting input and of its inverting input while there is offset Voff between its non-inverting input and its inverting input.

In other words, in this third step, comparator COMP determines whether V−-IIc+Voff is greater or not than 0, that is, whether VCL+VTH−-(Ic−I)−VCL−Voff+Voff is greater or not than 0, which amounts to comparing Ic−I with threshold VTH−, having suppressed the influence of input offset voltage Voff.

During the third step, signal ENB is switched to the active state to update signal det.

In a fourth step, switch IT1 is switched to the off state and switch IT2 is switched to the on state, and, further, switch IT+ is switched to the on state and switch IT− is switched to the off state. In this third step, the electrode 425 of capacitor Cdiff is floating.

During the fourth step, comparator COMP compares difference I−Ic with threshold VTH+, having suppressed the influence of voltage Voff.

During the fourth step, signal ENB is switched to the active state to update signal det.

The implementation of the third and fourth above steps amounts to comparing the absolute value of the difference between signals I and Ic with the absolute value of thresholds VTH+ and VTH−, by suppressing, during these two comparisons, the influence of input offset voltage Voff. As an example, the steps described hereabove may be implemented by supplying signal Ic to electrode 423 during the third step and signal I to electrode 423 during the fourth step without for this to alter the implemented functionality, that is, to compare the absolute value of the difference between signals I and Ic with the absolute value of thresholds VTH+ and VTH−.

The four above-described steps are also implemented to compare the absolute value of the difference between signals Q and Qc with the absolute value of thresholds VTH+ and VTH−, by supplying signal Q to electrode 423 during the second step, and signal Qc to electrode 423 during the third step (or vice versa).

FIG. 7 shows another example of implementation of the circuit CIRC1 of the pixel of FIG. 4. To avoid overloading the drawing, gates 400, 402, 404, 406, 410, 414, 418, and 422, and memories 408, 412, 416, and 420 are not shown. In this example, pixel PIX comprises a single photodetector PD, preferably a pinned photodiode, and the transfer gates 400, 402, 404, and 406 are connected to photodetector PD in the same way as in FIG. 4.

In this example, circuit CIRC1 is configured to suppress the thermal noise generated on node SN during operations of resetting of the latter, this noise being, for example, referred to as KT/C noise.

Thus, as compared with what has been described in relation with FIG. 4, the circuit CIRC1 of FIG. 7 further comprises:
a capacitor Cth having an electrode 700 connected to the source of transistor MSF and another electrode 702 connected to the gate of a MOS transistor mounted as a source follower MSF2, and
a switch ITth connected between the electrode 702 of capacitor Cth and reference potential GND.

Circuit CIRC1 further comprises a current source 704 configured to supply a bias current to transistor MSF2, that is, to a conduction terminal of transistor MSF2, for example its source. Transistor MSF2 and current source 704 are coupled in series between potentials VDD and GND. The source of transistor MSF2 then corresponds to the output of the circuit CIRC1 on which signals I, Ic, Q and Qc will be available, sequentially in this example.

Optionally, but preferably, transistor MSF2 is of the opposite channel type to that of transistor MSF in order to limit voltage drops between the gate of transistor MSF and the source of transistor MSF2. For example, in FIG. 7, transistor MSF has an N channel, transistor MSF2 has a P channel and has its source connected to current source 704 and its drain connected to potential GND.

The operation of circuit CIRC1 is then modified as follows. During a step of initialization of node SN (ITrst on), switch ITth is set to the on state. The voltage on the electrode 700 of capacitor Cth is then equal to RST+kTC (neglecting voltage drops in switch ITrst and between the gate and source of transistor MSF), with kTC the thermal noise on node SN. Then, switch ITth is switched to the off state, and one of gates 410, 414, 418, or 422 is set to the on state. As a result, node SN is at a voltage equal to Vsig+kTc, where Vsig is determined by the charges stored in memory 408, 412, 416, or 420, which is coupled to node SN by the on state of gate 410, 414, 418, or 422, respectively. The voltage on the electrode 702 of capacitive element Cth is then equal to Vsig+kTc−(RST+kTC) (neglecting the voltage drop between the gate and source of transistor MSF), and thus to Vsig-RST. This voltage Vsig-RST, from which the influence of the reset thermal noise has been suppressed, is then found at the source of the MSF2 transistor (neglecting the gate-source voltage drop of the MSF2 transistor) and corresponds to signal I, Ic, Q, or Qc, depending on whether the gate which has been switched to the on state is gate 410, 414, 418 or 422, respectively.

The circuit CIRC1 described in relation with FIG. 7 may be used with the circuits CIRC2 and CICR3 such as described in relation with FIG. 4, or with the circuits CIRC2 and CIRC3 such as described in relation with FIG. 6.

FIG. 8 shows another example of implementation of the circuit CIRC1 of the pixel PIX of FIG. 1.

In this example, pixel PIX comprises a single photodetector PD, preferably a pinned photodiode.

The circuit CIRC1 of FIG. 8 differs from the circuit CIRC1 of FIG. 4 in that:

the assembly formed of elements ITrst, SN, MSF, and 424 is duplicated (elements ITrst′, SN′, MSF′, and 424′ in FIG. 8), gates 418 and 422 couple the respective memories 416 and 420 to node SN′ rather than to node SN.

Thus, as compared with the circuit CIRC1 of FIG. 4 comprising a single output on which signals I, Ic, Q, and Qc are sequentially available, the circuit CIRC1 of FIG. 8 comprises a first output sequentially delivering signals I and Ic, and a second output sequentially delivering signals Q and Qc.

In the example of FIG. 8, the first output of circuit CIRC1 corresponds to the source of transistor MSF, and the second output of circuit CIRC1 corresponds to the source of transistor MSF′.

In another example not shown, the circuit CIRC1 of FIG. 8 is further configured to suppress the thermal noise on nodes SN and SN′, similarly to what has been described in relation with FIG. 7. For example, a first assembly of a capacitive element Cth, of an ITth switch, of an MSF2 transistor, and of a current source 704 is connected to the source of transistor MSF, and a second assembly of a capacitive element Cth, of a switch ITth, of a transistor MSF2, and of a current source 704 is connected to the source of transistor MSF′. The source of the transistor MSF2 of the first assembly then forms a first output of the circuit CIRC1 delivering signals I and Ic, and the source of the transistor MSF2 of the second assembly then forms a second output of the circuit CIRC1 delivering signals Q and Qc.

As an example, these two outputs of circuit CIRC1 may be selectively coupled to the input of a single circuit CIRC2 as described in relation with FIG. 4 or with FIG. 6, so that the operation of circuits CIRC2 and CIRC3 is identical to what has been previously described in relation with FIG. 4.

As an alternative example, all the components of the circuits CIRC2 and CIRC3 described in relation with FIG. 4 or with FIG. 6 are duplicated. For example, a first of these two assemblies is connected to the first output of circuit CIRC1, a second of these two assemblies is connected to the second output of circuit CIRC1, and signal det is determined from the outputs of the two assemblies. This enables to implement the comparison of the absolute value of the difference between signals I and Ic with the absolute value of thresholds VTH+ and VTH− in parallel with the implementation of the comparison of the absolute value of the difference between signals Q and Qc with the absolute value of thresholds VTH+ and VTH−. However, manufacturing dispersions between the components of the first assembly and those of the second assembly may introduce an offset between signals IIc and QQc. Those skilled in the art will be capable of adapting the sequences of control of the gates and of the switches of the circuits CIRC1, CIRC2, and CIRC3 of this alternative example based on the description given in relation with FIGS. 4, 5, 6, and 7.

Although other examples of implementations of circuit CIRC1 have been described hereabove in the case where pixel PIX comprises a single photodetector PD, these examples of circuits CIRC1 may be implemented in a pixel PIX comprising two photodetectors PD, preferably identical. For example, gates 400 and 402 are then connected to one of the two photodetectors PD, and gates 404 and 406 are connected to the other of the two photodetectors PD. In this case, the duration of each of time periods D1, D2, D3, and D4 may be greater than that of time periods D1, D2, D3, and D4 in the case where pixel PIX comprises a single photodetector. For example, each of durations D1, D2, D3, and D4 has a value equal to Ts/2. Those skilled in the art will be capable of adapting the sequences of control of the gates and of the switches of the circuits CIRC1, CIRC2, and CIRC3 of this alternative example based on the description made in relation with FIGS. 4, 5, 6, 7, and 8.

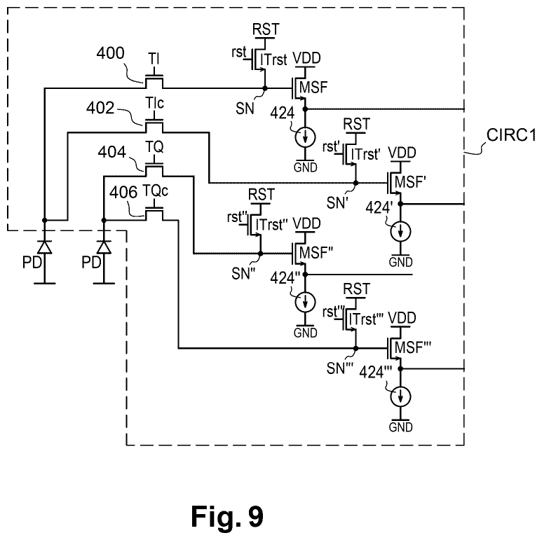

FIG. 9 shows another example of implementation of the circuit CIRC1 of the pixel PIX of FIG. 1.

In this example, pixel PIX comprises two photodetectors PD.

Circuit CIRC1 comprises the four gates 400, 402, 404, and 406, controlled by the respective signals TI, TIc, TQ, and TQc. Gates 400 and 402 each have a first conduction terminal connected to a first of the two photodetectors PD, gates 404 and 406 each having a first conduction terminal connected to the second of the two photodetectors PD.

However, unlike the circuits CIRC1 described up to now, in the circuit CIRC1 of FIG. 9, gates 400, 402, 404, and 406 have their second terminals connected to respective nodes SN, SN′, SN″, and SN″, these nodes being used as a memory for storing the photogenerated charges transferred from photodetectors PD by gates 400, 402, 404, and 406. Advantageously, it is thus not necessary to provide intermediate memories 408, 412, 416, and 420.

As described in relation with the circuit CIRC1 of FIG. 4, node SN is coupled to potential VDD by switch ITrst and is connected to the gate of follower transistor MSF, transistor MSF being in series with current source 424 between potentials VDD and GND so that the voltage on its source is an image of the voltage on its gate. Similarly, node SN′ is coupled to potential VDD by a switch ITrst′ and is connected to the gate of a follower transistor MSF′, transistor MSF′ being in series with a current source 424′ between potentials VDD and GND so that the voltage on its source is an image of the voltage on its gate, node SN″ is coupled to potential VDD by a switch ITrst″ and is connected to the gate of a follower transistor MSF″, transistor MSF′ being in series with a current source 424″ between potentials VDD and GND so that the voltage on its source is an image of the voltage on its gate, and node SN″ is coupled to potential VDD by a switch ITrst″ and is connected to the gate of a follower transistor MSF″, transistor MSF″ being in series with a current source 424″ between potentials VDD and GND so that the voltage on its source is an image of the voltage on its gate. Switches ITrst, ITrst′, ITrst″, and ITrst″ are controlled by respective signals rst, rst′, rst″, and rst″.

In the example of FIG. 9, time periods D1, D2, D3, and D4 each have a value for example equal to Ts/2. Those skilled in the art will be capable of adapting control signals TI, TIc, TQ, and TQc to the example of circuit CIRC1 of FIG. 9, based on the description made above in relation with FIGS. 4, 5, 6, 7, and 8 of the other examples of pixels PIX.

In another example not shown, the pixel PIX of FIG. 9 comprises a single photodetector PD, and all the gates have their first conduction terminals connected to this single photodetector PD. In this case, time periods D1, D2, D3, and D4 each have a value equal to Ts/4, for example.

In the example of FIG. 9, the source of transistor MSF corresponds to a first output of circuit CIRC1 delivering signal I, the source of transistor MSF′ corresponding to a second output of circuit CIRC1 delivering signal Ic, the source of transistor MSF″ corresponding to a third output of circuit CIRC1 delivering signal Q, and the source of transistor MSF″ corresponding to a fourth output of circuit CIRC1 delivering signal Qc.

In another example not shown, the source of transistor MSF is coupled to a first output of circuit CIRC1 by a first assembly of components Cth, ITth, MSF2, and 704 such as described in relation with FIG. 7, the source of transistor MSF′ is coupled to a second output of circuit CIRC1 by a second assembly of components Cth, ITth, MSF2, and 704 such as described in relation with FIG. 7, the source of transistor MSF″ is coupled to a third output of circuit CIRC1 by a third assembly of components Cth, ITth, MSF2, and 704 such as described in relation with FIG. 7, and the source of transistor MSF″ is coupled to a fourth output of circuit CIRC1 by a fourth assembly of components Cth, ITth, MSF2, and 704 as described in relation with FIG. 7.

As compared with the circuit CIRC1 of FIG. 4 comprising a single output or with the circuit CIRC1 of FIG. 8 comprising two outputs, the circuit CIRC1 of FIG. 9 comprises four outputs delivering the respective signals I, Ic, Q, and Qc.

As an example, these four outputs of circuit CIRC1 may be selectively coupled to the input of a single circuit CIRC2 as described in relation with FIG. 4 or with FIG. 6, so that the operation of circuits CIRC2 and CIRC3 is identical to what has been described hereabove.

As an alternative example, all the components of the circuits CIRC2 and CIRC3 described in relation with FIG. 4 or FIG. 6 are duplicated. For example, a first of these two assemblies is selectively connected to the first and second outputs of circuit CIRC1, so as to selectively receive either signal I or signal Ic, and a second of these two assemblies is selectively connected to the third and fourth outputs of circuit CIRC1 so as to selectively receive either signal Q or signal Qc. Signal det is then determined from the outputs of the two duplicated assemblies. This enables to implement the comparison of the absolute value of the difference between signals I and Ic with the absolute value of thresholds VTH+ and VTH− in parallel with the comparison of the absolute value of the difference between signals Q and Qc with the absolute value of thresholds VTH+ and VTH−. Those skilled in the art will be capable of adapting the sequences of control of the gates and of the switches of the circuits CIRC1, CIRC2, and CIRC3 of this alternative example based on the description made of the operation of the previously-described examples of circuits CIRC1, CIRC2, and CIRC3.

Further, embodiments of pixels PIX configured to operate in the charge domain have been described hereabove, that is, the photodetector(s) PD of the described pixels are preferably pinned photodiodes, and gates 400, 402, 404, 406 are transfer gates. In alternative embodiments, pixel PIX, and in particular its circuit CIRC1, are configured to operate in the voltage domain, that is, the photodetector(s) PD of the pixel may be conventional (non-pinned) photodiodes and it is the currents supplied by these photodetectors which are integrated, for example with capacitive transimpedance amplifiers (CTIA).

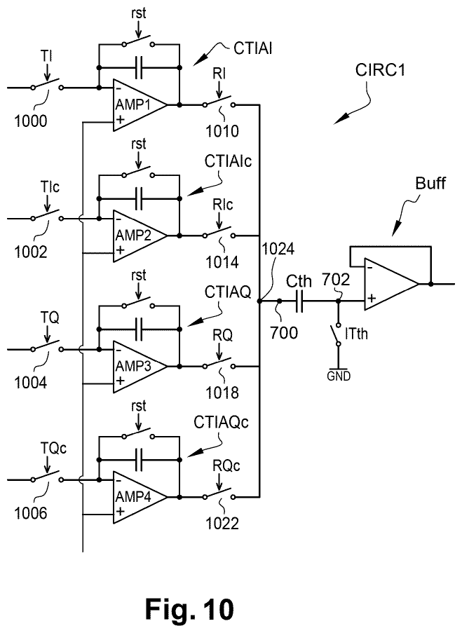

FIG. 10 shows another example of implementation of a circuit CIRC1 of the pixel PIX of FIG. 1. In this alternative embodiment, pixel PIX is configured to operate in the voltage domain.

In FIG. 10, only circuit CIRC1 is shown, the other circuits CIRC2, CIRC3, and CIRC4 being, for example, identical to those previously described.

In the circuit CIRC1 of FIG. 10, gates 400, 402, 404, and 406 are replaced by switches, respectively 1000, 1002, 1004, and 1006. Switches 1000, 1002, 1004, and 1006 are controlled by signals TI, TIc, TQ, and TQc, respectively, similar to those described in relation with the circuits CIRC1 operating in the charge domain.

Switches 1000, 1002, 1004, and 1006 may, similarly to gates 400, 402, 404, and 406, have their first conduction terminals all connected to a single photodetector PD of the pixel, which may be a non-pinned photodiode. As an alternative example, in a pixel PIX with two photodetectors that may be non-pinned photodiodes, switches 1000 and 1002 have their first conduction terminals connected to a first of the two photodetectors, and switches 1004 and 1006 have their first conduction terminals connected to a second of the two photodetectors. As another alternative example, in a pixel PIX with four photodetectors which may be non-pinned photodiodes, switches 1000, 1002, 1004, and 1006 each have their first conduction terminal connected to a separate photodetector.

In the circuit CIRC1 of FIG. 10, memories 408, 412, 416, and 420 are replaced by operational amplifiers mounted as capacitive transimpedance amplifiers (CTIA), respectively designated with references CTIAI, CTIAIc, CTIAQ, and CTIAQc in FIG. 10.

Switches 1000, 1002, 1004, and 1006 have their second conduction terminals coupled, for example connected, to the respective amplifiers CTIAI, CTIAIc, CTIAQ, and CTIAQc.

Each capacitive transimpedance amplifier comprises a reset switch coupling the output and the input, for example inverting, of the amplifier. This reset switch is, for example, controlled by a signal rst. The switching to the on state of the reset switch of a capacitive transimpedance amplifier enables to reset to zero the value integrated in the amplifier, and more particularly the value integrated in the capacitance of the capacitive transimpedance amplifier.

In the circuit CIRC1 of FIG. 10, transfer gates 410, 414, 418, and 422 are replaced by switches, respectively 1010, 1014, 1018, and 1022. Switches 1010, 1014, 1018, and 1022 are controlled by signals, respectively RI, RIc, RQ and RQc, similar to those described in relation with the circuits CIRC1 operating in the charge domain. Each switch 1010, 1014, 1018 and 1022 has a first conduction terminal connected to the output of an amplifier, respectively CTIAI, CTIAIc, CTIAQ, and CTIAQc.

As an example, the second conduction terminals of the switches are all connected to a same node 1024, as is the case in the example of FIG. 10. As an example, this node 1024 may correspond to the output of circuit CIRC1. As an alternative example, as illustrated in FIG. 10, node 1024 is coupled to the output of circuit CIRC1 by a thermal noise suppression circuit.

This thermal noise suppression circuit comprises, similarly to what has been described previously, for example in relation with FIG. 7:
a capacitor Cth having an electrode 700 connected to node 1024 and another electrode 702 connected to the input of an analog buffer circuit Buff, and
a switch ITth connected between the electrode 702 of capacitive element Cth and reference potential GND.

Circuit Buff is an alternative to follower transistor MSF2, which is more bulky but which has no gate-source voltage drop. As an example, the implementation described in relation with FIG. 10 is relevant in a sensor where the photodiodes PD of a plurality of pixels PIX are arranged in a single row of photodetectors PD.

In the example of FIG. 10, all switches 1010, 1014, 1018, and 1022 have their second conduction terminals connected to a same node 1024.

In other examples not shown, the second conduction terminals of switches 1010 and 1014 are connected to the same first node, and the second conduction terminals of switches 1018 and 1022 are connected to a same second node. The first and second nodes may correspond to the outputs of circuit CIRC1, or each may be coupled to a corresponding output of circuit CIRC1 via a thermal noise suppression circuit.

In yet other examples not shown, the second conduction terminals of switches 1010, 1014, 1018, and 1022 are each connected to a separate node that may correspond to an output of circuit CIRC1, or be coupled to a corresponding output of circuit CIRC1 via a thermal noise suppression circuit. In such examples, switches 1010, 1014, 1018, and 1022 may be omitted.

In the above-described pixels PIX, to detect (or test or verify) whether a pixel PIX is at a distance z equal to zdet from a scene, it is sufficient to emit the frequency-modulated continuous wave light signal with a slope B/T equal to fs·c/(2·zdet). Value zdet can thus be modified, either by modifying slope B/T, by modifying frequency fs, or by modifying both parameters.

Thus, according to an embodiment, the control circuit is configured to maintain frequency fs constant at each transmission of a plurality of transmissions of the frequency-modulated continuous wave signal, and to modify the slope of the frequency modulation at each transmission. Thus, at each transmission of the plurality of transmissions of the frequency-modulated continuous wave signal, the corresponding integration period enables to detect a different distance from the sensor to the scene.

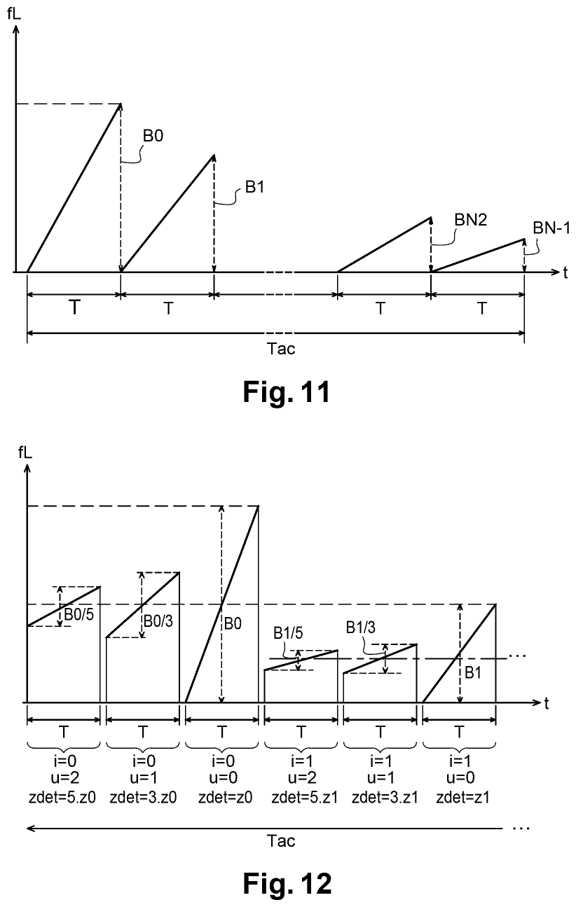

FIG. 11 illustrates, in timing diagrams, an example of operation in which, during an acquisition period Tac, N integration periods are implemented and all correspond to the transmission of a frequency-modulated continuous wave light signal for a time period Ti with a slope Bi/Ti, with i an integer index ranging from 0 to N−1.

More particularly, in the example of FIG. 11, frequency fs is constant for each of the N transmission periods, and duration Ti is constant and equal to T for each of the N transmission periods. Further, at each transmission period of duration T, slope Bi/Ti is changed, in this example by changing the value of the amplitude Bi of the range of variation of the frequency fL of the transmitted optical signal since Ti is constant and equal to T.

In the example of FIG. 11, for a given value of frequency fs, which is kept constant during the N successive transmission periods, it is thus possible, with a pixel PIX, to detect N different distances zi equal to (fs·c·T)/(2·Bi) at the end of acquisition period Tac. In other words, in this case, pixel PIX enables to check, for each of the N different distances zi, whether or not pixel PIX is at this distance zi from the scene, that is, whether or not pixel PIX is at this distance zi from the point in the scene associated with this pixel PIX.

Although this is not shown in FIG. 11, in practice, between two successive transmissions of indices i and i+1, a dead time corresponding to a time d of processing by pixel PIX may be provided to determine whether or not pixel PIX should set its signal det to the active state. This processing time corresponds, for example, to the time required for pixel PIX to generate each of signals IIc and QQc and to compare them with voltages V+ and V−. As a variant, the determination of whether or not pixel PIX should set its signal det to the active state is made while pixel PIX integrates the signal of the next transmission period. This processing time is thus hidden, and there then is no need to provide a dead time between two successive integration periods.

In the above example, when the absolute value of thresholds VTH− and VTH+ is set to too low a value, there may result that, for a given slope Bi/T corresponding to a distance to be detected zi, a received signal sigL having a beat frequency equal to (2·u+1)·fs, with u an integer greater than or equal to 1, triggers pixel PIX (det active at the output of pixel PIX). For example, if thresholds VTH− and VTH+ are too low, the signals 304 and 310, or even also the signals 308 and 306, of FIG. 3 can trigger pixel PIX. In other words, for a given slope Bi/T, pixel PIX will deliver an active signal det as if the point in the scene associated with pixel PIX were at a distance zi=(fs·c·T)/(2·Bi) from the pixel, whereas the point in the scene associated with pixel PIX is in fact at a distance equal to (2·u+1)·zi from the pixel.

According to an embodiment, upon detection by a pixel PIX of N successive distances zi=z0·kⁱ=(fs·c·T)/(2·Bi)=kⁱ·(fs·c·T)/(2·B0), with i increasing, z0 an initial distance, B0 a frequency excursion determined by z0, and k a resolution factor between distances, it is provided, for each index i, to successively detect distances (2·u+1)·zi=(2·u+1)·z0·kⁱ=(2·u+1)·kⁱ·(fs·c·T)/(2·B0) with u a decreasing integer ranging from U to 0, and U a positive integer, for example equal to 2. For this purpose, for each value of index i, U+1 successive transmission periods of duration T and of respective amplitudes (or excursions) Bi/(2·u+1)=B0/(kᵢ·(2·u+1)) are provided, with u a decreasing index ranging from U to 0. This enables, for a slope and frequency fs pair, to first detect the distances corresponding to odd harmonics of this frequency fs and to resolve ambiguities concerning the detected distance.

For each given value of index i, it is preferable for the frequency excursion ranges Bi/(2·u+1) for this given value of index i to have the same average value, so that the corresponding signals sigL received by pixel PIX are comparable. Indeed, when the coherent light source is a semiconductor laser, the modulation of the injection current which is applied to the laser to modulate its optical frequency generates at the same time a modulation of the intensity (or optical power) of the laser. It is thus preferable to have a substantially identical average intensity value between the transmission periods U+1 of a given index i, since the amplitude of the oscillations (at beat frequency fR) is proportional to this average value.

FIG. 12 illustrates, over an acquisition period Tac, the above-described principle for U equal to 2 and for indices i equal to 0 and i equal to 1.

In this example, durations Ti are all equal to a same duration T. For each transmission period T, FIG. 12 indicates the value of the pair of indices i and u, and the distance zdet actually detected (tested) by pixel PIX.

In the example of FIG. 12, between each two successive transmissions corresponding to two different pairs of indices i and u, there is a dead time corresponding to a time of processing by pixel PIX to determine whether or not the signal det of the pixel should be activated. As a variant, as previously indicated, this processing time at the end of each transmission period is masked during the beginning of the next transmission period, and there is then no dead time between transmission periods.

If, for the transmission period corresponding to a given pair of indices i and u of acquisition period Tac, pixel PIX delivers an active signal det, it is no longer necessary to check whether pixel PIX will deliver an active signal det for the subsequent transmission periods of this acquisition period Tac, and pixel PIX can then be disabled for these subsequent transmission periods. The distance actually detected by the pixel then is distance zdet=((2·u+1)·zi=(2·u+1)·z0·kⁱ=(2·u+1)·kⁱ·(fs·c·T)/(2·B0), with i and u the indices of the pair of indices i and u corresponding to the transmission period having caused the delivery of an active signal det by pixel PIX.

Preferably, for each value of index i, each distance zdet=zi which is equal to a distance zdet=(2·u+1)·zj with j an integer ranging from 0 to i−1 and u in the range from 1 to U, the transmission of the signal corresponding to the pair of indices i and u=0 can be omitted since distance zdet=zi=(2·u+1)·zj has already been tested for the pair of indices j and u.

In other words, preferably, the transmission periods satisfying, for u ranging from 1 to U, i ranging from 0 to N, and j ranging from 0 to i−1, the equality (2·u+1)·kⁱ=kⁱ, do not need to be duplicated. The above equality is equivalent to the equality i−j=log (2·u+1), with logₖ the base-k logarithm operator. By selecting resolution factor k so that, for at least certain values of index u in the range from 1 to U, log (2·u+1) is equal to an integer, it is thus possible to decrease the number of transmission periods.

Thus, according to an embodiment at a constant integration frequency fs, it is thus provided, for each value of an increasing index i ranging from 0 to N−1, for a decreasing index u ranging from U to 0, to transmit a continuous frequency-modulated wave signal with a frequency excursion equal to B0/(kⁱ·(2·u+1) only if, for a given resolution value k and for an integer q ranging from 1 to U, logₖ(2·q+1) is different from i−j, with j an integer index ranging from 0 to i−1. Preferably, during the successive above-defined transmissions, a pixel PIX delivering an active signal for one of said transmissions is deactivated for the next transmissions.

Embodiments in which the slope of the frequency modulation is changed between successive transmissions of a frequency-modulated continuous wave signal while frequency fs is kept constant for the corresponding integration periods have been described hereabove.

More particularly, in these embodiments, the slope of the frequency modulation is changed by changing the frequency excursion of the modulation while the duration of the modulation (or transmission) is kept constant. In alternative embodiments, the slope is modified by changing the duration of each transmission, the excursion of the frequency modulation being able to be kept constant or to be also modified between successive transmissions. The adaptation of the above disclosure to such alternative embodiments is within the abilities of those skilled in the art based on the functional indications given hereabove for the case where the transmission duration is kept constant and equal to T.

Further, to detect (or test) a plurality of distances from a pixel PIX to a scene, rather than varying the slope of the frequency modulation at each transmission of a plurality of transmissions of a frequency-modulated continuous wave signal, it is possible to keep a constant frequency modulation slope for all transmissions by varying frequency fs.

Thus, according to an embodiment, the control circuit is configured to keep the slope of the frequency modulation constant at each transmission of a plurality of transmissions of the frequency-modulated continuous wave signal, and to change the value of frequency fs at each transmission. Thus, at each transmission of the plurality of transmissions of the frequency-modulated continuous wave signal, the corresponding integration period enables to detect a different distance from the sensor to the scene.

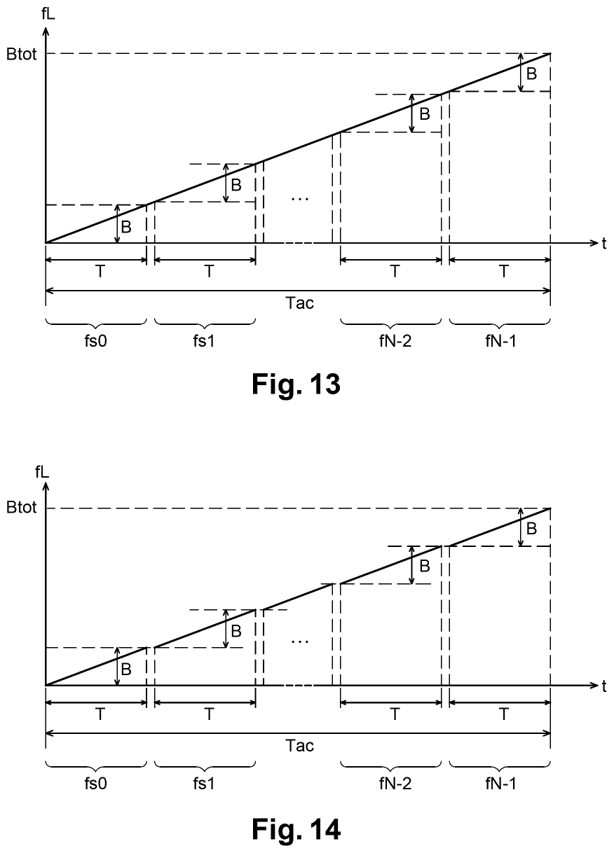

FIG. 13 illustrates, in timing diagrams, an example of operation in which, during an acquisition period Tac, N transmission periods are implemented and all correspond to the transmission of a frequency-modulated continuous wave light signal with a constant slope, for example equal to B/T with B constant and T constant, but with a different integration frequency fsi, with i an index ranging from 0 to N−1.

More particularly, in the example of FIG. 13, the frequency-modulated continuous wave signal is transmitted continuously over the entire time period Tac with an excursion of the frequency modulation equal to Btot and a frequency modulation fL uninterrupted over the entire time period Tac. Btot is determined so that, for each of the N transmission periods, the slope of the frequency modulation is constant and, in this example, equal to B/T. Further, at each of the N transmission periods, integration frequency fsi is modified, with i an integer ranging from 0 to N−1. Thus, each transmission period of duration T and of constant slope B/T corresponding to index i enables to detect a distance zi=(c·T·fsi)/(2·B).

As shown in FIG. 13, in practice, between two successive transmissions of indices i and i+1, a dead time corresponding to the time of processing by pixel PIX may be provided to determine whether signal det should be activated or not. Excursion Btot is then determined by taking these dead times into account, since, in this example, the modulation of frequency fL does not stop during these processing times. As a variant, as previously indicated, this processing time at the end of each transmission period is masked during the beginning of the next transmission period, and there is then no dead time between transmission periods.

FIG. 14 illustrates, in timing diagrams, another example of operation in which, during an acquisition period Tac, N integration periods are implemented and all correspond to the transmission of a frequency-modulated continuous wave light signal with a constant slope B/T, for example equal to B/T with B constant and T constant, but with a different integration frequency fsi, with i an index ranging from 0 to N−1.

More particularly, in the example of FIG. 14, as compared with the example of FIG. 13, the modulation of frequency fL is interrupted between each two successive transmission periods of indices i and i+1, during the time of processing by pixel PIX. Further, in the example of FIG. 14, for each two successive transmission periods of indices i and i+1, the modulation frequency fL at the beginning of the transmission period of index i+1 is equal to the modulation frequency at the end of the transmission period of index i.

As a result, for identical values of N, B, and T, the frequency excursion Btot of the modulation over the entire time period Tac in the example of FIG. 14 is lower than in the example of FIG. 13.

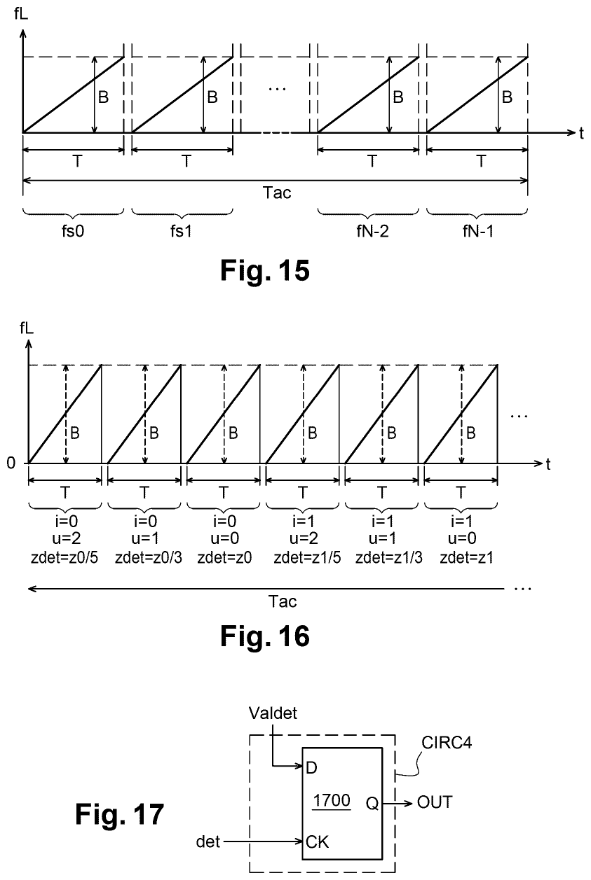

FIG. 15 illustrates, in timing diagrams, another example of operation in which, during an acquisition period Tac, N integration periods are implemented and all correspond to the transmission of a frequency-modulated continuous wave light signal with a constant slope, for example equal to B/T, but at a different integration frequency fsi, with i an index ranging from 0 to N−1.

More particularly, in the example of FIG. 15, as in the example of FIG. 14, the modulation of frequency fL may be interrupted between each two successive transmission periods of indices i and i+1, during a dead time corresponding to the time of processing by pixel PIX. However, in the example of FIG. 15, the value of modulation frequency fL is the same at the beginning of each transmission period. As a variant, as previously indicated, this processing time at the end of each transmission period is masked during the beginning of the next transmission period, and there is then no dead time between transmission periods.

An advantage of the embodiment of FIG. 15 over those of FIGS. 13 and 14 is that the total excursion Btot of the frequency modulation is smaller, and is equal to B in FIG. 15. Another advantage of the embodiment of FIG. 15 over those of FIGS. 13 and 14 is that the average intensity of the laser and the amplitude of the oscillations of signal sigL vary less between two successive transmission periods.

Those skilled in the art will be capable of providing other examples of operation by combining the examples in FIGS. 13, 14, and 15.

For example, the N successive transmission periods may be grouped into Q successive sets, each comprising a plurality of successive transmission periods, with Q an integer greater than 1. In each of the Q sets of a plurality of successive transmission periods, modulation frequency fL may be modified continuously by interrupting or not the variation in the modulation frequency interrupted during each processing time separating two successive transmissions, and by having a same modulation frequency value at the beginning of the first transmission period of each of the Q sets of a plurality of successive transmission periods.

In the above examples, for a given value of the frequency modulation slope, which is kept constant and equal to B/T during the N successive transmissions (or integrations), it is thus possible, with a pixel PIX, to detect N different distances zi equal to (fsi·c·T)/(2·B) at the end of acquisition period Tac. In other words, in this case, pixel PIX enables to verify for each of the N different distances zi whether or not pixel PIX is at this distance zi from the scene, that is, whether pixel PIX is at this distance zi from the point in the scene associated with this pixel PIX.

In the above examples, when the absolute value of thresholds VTH− and VTH+ is set to too low a value, there may result that, for a given frequency fsi corresponding to a distance zi to be detected, a received signal sigL having a beat frequency equal to fsi/(2·u+1), where u is an integer greater than or equal to 1, triggers pixel PIX (det active at the output of pixel PIX). For example, if, thresholds VTH− and VTH+ are too low, signals 304 and 310, or even also signals 308 and 306, in FIG. 3 can trigger pixel PIX. In other words, for a given frequency fsi, pixel PIX will deliver an active signal det, as if pixel PIX had detected a point at a distance zi=(fsi·c·T)/(2·B) while the point detected by the pixel is in fact at a distance equal to zi/(2·u+1).

According to an embodiment, during the detection by a pixel PIX of N successive distances zi=z0·kⁱ=(fsi·c·T)/(2·B)=kⁱ·(fs0·c·T)/(2·B), with i increasing, z0 an initial distance, and k a resolution factor between distances, it is provided, for each index i, to successively detect distances zi/(2·u+1)=(z0·kⁱ)/(2·u+1)=kⁱ·(fs0·c·T)/((2·u+1)·2·B) with u a decreasing integer ranging from U to 0, and U a positive integer, for example equal to 2. For this purpose, for each value of index i, U+1 successive transmission periods corresponding to U+1 successive values of integration frequencies fsi/(2·u+1)=kⁱ·fs0/(2·u+1) are provided, with u a decreasing index ranging from U to 0. This enables, for a pair of slope and frequency fsi, to first detect the distances corresponding to the odd harmonics of this frequency fsi and to resolve ambiguities concerning the detected distance.

FIG. 16 illustrates, over an acquisition time period Tac, the principle described hereabove for U equal to 2 and for indices i equal to 0 and i equal to 1, for an example where the frequency modulation at each transmission period is of the type described in relation with FIG. 15.

For each transmission period T, FIG. 16 shows the value of the pair of indices i and u, and the distance zdet actually detected (tested) by pixel PIX.

If, for the transmission period corresponding to a given pair of indices i and u of acquisition period Tac, pixel PIX delivers an active signal det, it is no longer necessary to verify whether pixel PIX will deliver an active signal det for the subsequent transmission periods of this acquisition period Tac, and pixel PIX can then be disabled for these subsequent transmission periods. The distance actually detected by the pixel is then distance zdet=zi/(2·u+1)=z0·kⁱ/(2·u+1)=kⁱ·(fs0·c·T)/((2·u+1)·2·B0), with i and u the indices of the pair of indices i and u corresponding to the transmission period having caused the delivery of an active signal by pixel PIX.

Preferably, for each value of index i, each distance zdet=zi which is equal to a distance zdet=zj/(2·u+1), with j an integer ranging from 0 to i−1 and u in the range from 1 to U, the transmission of the signal corresponding to the pair of indices i and u=0 may be omitted since distance zdet=zi=zj/(2·u+1) has already been tested for the pair of indices j and u.

In other words, preferably, the transmission periods satisfying, for u ranging from 1 to U, the equality k^{j}/(2·u+1)=kⁱ, do not need to be duplicated. The above equality is equivalent to the equality i−j=logₖ(1/(2·u+1)), with logₖ the base-k logarithm operator. By selecting resolution factor k so that, for at least certain values of index u in the range from 1 to U, logₖ(1/(2·u+1)) is equal to an integer, it is thus possible to decrease the number of transmission periods.

Thus, according to an embodiment at constant frequency modulation slope, for each value of an increasing index i ranging from 0 to N−1, for an index u decreasing from U to 0, it is thus provided to transmit a frequency-modulated continuous wave signal with an integration frequency equal to kⁱ·fs0/(2·u+1) only if, for a given resolution value k, and for an integer q ranging from 1 to U, logₖ(1/(2·q+1)) is different from i−j, with j an integer index ranging from 0 to i−1. Preferably, during the successive transmissions defined hereabove, a pixel PIX delivering an active signal det for one of said transmissions is disabled for the next transmissions.

In the examples of embodiments and variants of pixel PIX previously described in relation to FIGS. 1, 4, 6, 7, 8, 9, and 10, the circuit CIRC4 of pixel PIX is configured to implement an event-driven reading of pixel PIX, that is, so that pixel PIX is read only when the signal det of pixel PIX has been activated at the end of a corresponding integration.

However, in other examples, circuit CIRC4 is configured to allow a sequential reading of pixel PIX, that is, to read pixel PIX after each integration, regardless of whether signal det has been activated by pixel PIX at the end of this integration period.

For example, for this purpose, the circuit CIRC4 of the pixel is configured to store, after each integration period, the state of signal det when this state is valid, for example when signal ENB is active. This stored value of the state of signal det is then read by a readout circuit of the electronic system comprising pixel PIX.

For example, this electronic system is an image sensor comprising an array of pixels PIX, and the sensor readout circuit is configured to read, for example after each integration, the value stored in circuit CIRC4 by reading the rows of pixels of the array one after the other, and simultaneously all the pixels PIX in the row being read.

As another example, for an image sensor comprising an array of pixels PIX in which:
for a given acquisition period Tac, each pixel PIX which delivers an active signal det for a given integration period of acquisition period Tac is disabled for the next integration periods of this acquisition period; and
the circuit CIRC4 of each pixel PIX is configured to store, after each integration, a zero value if signal det has remained inactive, and a detected distance value if signal det has been activated, the sensor readout circuit may be configured to read the value stored in the circuit CIRC4 of each pixel PIX at the end of the acquisition period, by reading the rows of pixel of the array one after the other, and simultaneously all the pixels PIX of the row being read.

An example of the implementation of such a circuit CIRC4 is shown in FIG. 17.

In this FIG. 17, the circuit CIRC4 of pixel PIX receives, for example from a readout circuit of the electronic system comprising pixel PIX, a digital word Valdet indicating, at each integration period, the value zdet of the distance detected by pixel PIX. Circuit CIRC4 comprises a register 1700 configured to store this digital word Valdet if signal det switches to the active state, and to remain at a default zero value otherwise. As an example, signal Valdet is received by a data input D of register 1700, and signal det is received by a clock input CK of register 1700.

Thus, during an acquisition period comprising a plurality of integration periods, each corresponding to a transmission of a frequency-modulated continuous wave signal, when, at the end of an integration period, a pixel PIX sets its signal det to the active state to indicate that it is at the corresponding distance zdet from the scene, this distance zdet is stored by the circuit CIRC4 of pixel PIX, and pixel PIX is disabled for the next integration periods of the acquisition period.

At the end of the acquisition period, circuit CIRC4 is read by a sensor readout circuit comprising pixel PIX, that is, the distance zdet detected by pixel PIX during this acquisition period is read by the readout circuit. For example, the readout circuit reads a digital word OUT available at the output of register 1700, for example on an output Q of register 1700, this word OUT corresponding to the default zero value if pixel PIX has never activated its signal det during the acquisition period, and to the word Valdet stored if pixel PIX has activated its signal det at the end of an integration period of the acquisition period. Depending on the configuration of register 1700, the word Valdet stored in register 1700 when the signal det was active can be read bit by bit if the output of register 1700 is a serial output, or by simultaneously reading all the flip-flops of register 1700 if the output of register 1700 is a parallel output.

Thereby, a single reading of each of the pixels PIX of the sensor implemented at the end of each acquisition period enables to directly obtain an image of the distances from the sensor to the scene for this acquisition period.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove. In particular, the photodetectors PD of pixels PIX, the other components of pixels PIX, the circuits, not described, enabling to read pixels PIX, and, for example, circuits for processing the information obtained as a result of the reading of pixels PIX can all be implemented inside and on top of a single layer of a semiconductor material, that is, in a single tier, or, alternatively, may be distributed between a plurality of layers of semiconductor materials, that is, between a plurality of tiers, for example according to the technology designated by the acronym 3DSL.

1. Pixel comprising:
at least one photodetector;
a first circuit configured to deliver, after each integration period corresponding to a transmission period of a frequency-modulated continuous wave light signal, first, second, third, and fourth signals representative of a quantity of charges photogenerated in said at least one photodetector during first, second, third, and fourth time periods of the integration period repeated at an integration frequency, the second time periods being phase-shifted by Π/2 with respect to the first time periods, the third time periods being phase-shifted by Π with respect to the first time periods, the fourth time periods being phase-shifted by 3*Π/2 with respect to the first time periods, and the first, second, third, and fourth time periods all having a same duration;
a second circuit configured to deliver a fifth signal determined by the difference of the first and third signals, and a sixth signal determined by the difference of the second and third signals; and
a third circuit configured to:
compare each of the fifth and sixth signals (IIc, QQc) with a first voltage (V+) determined by a positive threshold (VTH+) and with a second voltage (V−) determined by a negative threshold (VTH−), the positive and negative thresholds having a same absolute value, (IIc, QQc) is greater than the first voltage (V+) or lower than the second voltage (V−) when a light signal (sigL) received by the pixel has a beat frequency equal to the integration frequency (fs).

2. Sensor comprising:
one or more pixels according to claim 1;
a coherent light source configured to deliver, at each transmission period, the frequency-modulated continuous wave light signal;
an optical device configured, at each transmission period, to transmit a first part of the frequency-modulated continuous wave signal to a scene and a second part of the frequency-modulated continuous wave light signal to each pixel, so that the light signal received by each pixel corresponds to the superposition of the second part of the frequency-modulated continuous wave light signal and of a reflection by a point in the scene associated with the pixel of the first part of the frequency-modulated continuous wave light signal.

3. Sensor according to claim 2, wherein the sensor comprises a control circuit configured to control a plurality of periods of transmission of the frequency-modulated continuous wave signal and, at each of said plurality of transmission periods, to keep constant a slope of the frequency modulation of the frequency-modulated continuous wave light signal and change a value of the integration frequency.

4. Sensor according to claim 2, wherein the sensor comprises a control circuit configured to control a plurality of periods of transmission of the frequency-modulated continuous wave signal, and, at each of said plurality of transmission periods, to keep constant a value of the integration frequency and change a slope of the frequency modulation of the frequency-modulated continuous wave light signal.

5. Sensor according to claim 2, wherein, after each integration period, the third circuit of each pixel is further configured to deliver an active detection signal if one and/or the other of the fifth and sixth signals is greater than the first voltage or smaller than the second voltage.

6. Sensor according to claim 5, wherein the first, second, and third circuits are configured so that, after each integration period, the detection signal is active:
if a difference between the first and third signals is, in absolute value, greater than the absolute value of the positive and negative thresholds; and/or
if a difference between the second and fourth signals is, in absolute value, greater than the absolute value of the positive and negative thresholds.

7. Sensor according to claim 5, wherein:
the sensor comprises an address event readout circuit; and
each pixel comprises an output circuit configured to detect that the detection signal is active and to deliver, as a result of a detection that the detection signal is active, an address signal of the pixel to the address event readout circuit, the output circuit and the address event readout circuit being preferably configured to communicate with each other according to a handshake protocol.

8. Sensor according to claim 2, wherein the sensor comprises a control circuit configured to:
keep the integration frequency constant during an acquisition period; and
during the acquisition period, for an increasing integer index i ranging from 0 to N−1, with N is a positive integer, and, for each value of index i, for a decreasing index u ranging from U to 0, with U a positive integer, control, for each pair of indices i and u, a period of transmission of the frequency-modulated continuous wave signal with an excursion of the frequency modulation equal to B0/(kⁱ·(2·u+1), with B0 a frequency excursion value determined by an initial value of the distance to be detected (z0) and k a positive resolution value, preferably only if, for q an integer ranging from 1 to U, logₖ(2·q+1) is different from i−j, with j an integer index ranging from 0 to i−1.

9. Sensor according to claim 2, wherein the sensor comprises a control circuit configured to keep a frequency modulation slope constant at each transmission period of an acquisition period; and
during the acquisition period, for an increasing integer index i ranging from 0 to N−1, with N is a positive integer, and, for each value of index i, for a decreasing index u ranging from U to 0, with U a positive integer, to control, for each pair of indices i and u, a period of transmission of the frequency-modulated continuous wave signal and a value of the integration frequency equal to ki·fs0/(2·u+1) with fs0 an integration frequency value determined by an initial value of the distance to be detected and k a positive resolution value, preferably only if, for q an integer ranging from 1 to U, logk(1/(2·q+1) is different from i−j, with j an integer index ranging from 0 to i−1.
